(19) United States
(12) Patent Application Publication
(10) Pub. No.: US 2005/0287500 A1
(43) Pub. Date: Dec. 29, 2005

(54) Apparatus and method for labeling and identifying the location of individuals

(76) Inventor: Amy L. Hubbard, (US)

Correspondence Address: KELLY LOWRY & KELLEY, LLP, 6320 CANOGA AVENUE, SUITE 1650, WOODLAND HILLS, CA, 91367, US

(21) Appl. No.: 11/165,628

(22) Filed: Jun. 24, 2005

Related U.S. Application Data
(60) Provisional application No. 60/521,735, filed on Jun. 28, 2004.

(51) Int. Cl. G09B 29/00

(52) U.S. Cl. 434/150

(57) ABSTRACT

An apparatus for labeling and identifying the location of individuals includes a display surface, including a map, and a plurality of markers releasably attachable to the display surface. Each marker includes an upper surface adapted be to written upon, or receive a label, with identifying indicia representing an individual. The location of an individual is identified and labeled by placing the marker representing that individual on the map of the display surface where that individual is located.

### RELATED APPLICATION

This application claims priority to U.S. Provisional Application Ser. No. 60/521,735, filed on Jun. 28, 2004.

### BACKGROUND OF THE INVENTION

The present invention generally relates to display devices and maps. More particularly, the present invention relates to an apparatus and method for labeling and identifying locations of individuals, such as family members and friends, on a map.

There exist a great many displays and marker apparatuses which have been previously proposed. Many of these are educational in nature. For example, U.S. Pat. No. 4,800,662 discloses a magnetic map marker wherein a marking unit of a predetermined shape, such as an airplane, resides on the front surface of the map, and a magnet is provided for the rear surface of the map to attract the marker and hold it in place, rotate it, or move it across the map as an interactive teaching aid for students.

U.S. Pat. No. 5,259,763 is directed to an educational teaching map in which a map is silk-screened onto a large piece of loop material. Tabs with hook material are selectively placeable on the map so as to identify, for example, names of states, names of cities, rivers, etc. U.S. Pat. No. 5,800,182 is directed to an interactive teaching aid in the form of a fabric chart kit containing a fabric panel, which may include a map, and easily removed related manipulative elements for teaching a variety of educational concepts. In the event that the indicia on the panel is a map of the United States, the participant student interacts with the map by attaching the manipulative element which bears some relationship to a particular area on the panel, for example, a capital of one of the 50 United States.

U.S. Pat. No. 5,496,176 discloses a military strategy map apparatus, wherein a panel containing a detailed map of an area of a battle is provided. Magnetic markers are provided to illustrate and alter weather patterns, and individual military units ranging in size from an entire army to a scout patrol. In this manner, a battle can be recreated by moving the markers as the military units were deployed in the historic battle.

However, the inventor is not aware of any maps or the like which would identify the location of individuals on a map. For example, in this day and age, it is common for family members and friends to move quite frequently. This may be due to attendance at a college, military training or deployment, or when employment requires moving. In some instances, the family members or friends may reside in various parts of an individual state. In other instances, these family members or friends may reside in different states of the United States, or even temporarily or permanently reside in different countries of the world. In any event, it would be helpful and enjoyable to be able to label each of the individuals or families on a map. The present invention fulfills these needs and provides other related advantages.

### SUMMARY OF THE INVENTION

The present invention resides in an apparatus and method for labeling and identifying the location of individuals. Generally, the apparatus comprises a display surface including a map. A plurality of markers are releasably attachable to the display surface, wherein each marker is adapted to include indicia representing an individual. The location of that individual is identified and labeled by placing the marker representing that individual on the map of the display surface where that individual is located.

The display surface map may comprise a map of the world, a continent, a country, or a state or province of a country. Typically, the map includes indicia identifying the one or more countries or states or provinces. Preferably, the map further includes landmark indicia of the one or more countries, or one or more states or provinces.

Preferably, a frame surrounds the display surface map to provide an aesthetically pleasing appearance. Means are provided for supporting the display surface map on a vertical surface, such as on a refrigerator or wall.

Each of the markers include an upper surface which is adapted to be written upon with identifying indicia of an individual. Alternatively, a label that is written upon with identifying indicia of the individual, is attached to or associated with the marker.

In a particularly preferred embodiment, the display surface is comprised of a magnetically attractable metal or magnetic material. Each of the markers are comprised of a magnetically attractable metal or magnetic material so as to be magnetically removably attached to the display surface.

In another embodiment, each of the markers includes a projection for insertion into the display surface map. For example, the display surface map may comprise peg board material, and the marker or projections comprise pegs insertable therein.

In yet another embodiment, the display surface map comprises hook or loop material having the map imprinted thereon. The markers include corresponding hook or loop material for removable attachment to the display surface map.

In accordance with the present invention, the identifying indicia representing an individual is written upon the upper surface of the marker, or a label which is attached to the marker. The marker is then placed on the map of the world, country, or state, etc., where the individual resides. Preferably, the display surface map is supported on a vertical surface such as a refrigerator or wall so as to be easily viewed. As the family members or friends change residences, their markers can be moved to a different geographic location corresponding to their new location.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view illustrating various components used in accordance with the present invention;

FIG. 2 is a partially fragmented perspective view of a framed display map having markers thereon and hung on a vertical surface, in accordance with the present invention;

FIG. 3 is a front elevational view illustrating a map of the United States with markers thereon, in accordance with the present invention;

FIG. 4 is a front perspective view of the apparatus of the present invention, illustrating a map of the world thereon;

FIG. 5 is an enlarged view of area “5” of FIG. 3, illustrating markers placed on a map having landmark indicia, in accordance with the present invention;

FIG. 6 is a diagrammatic view illustrating removable placement of the markers on the map;

FIG. 7 is a top plan view of a magnetic marker used in accordance with the present invention;

FIG. 8 is a bottom plan view of the magnetic marker of FIG. 7;

FIG. 9 is a side elevational view of the magnetic marker of FIG. 7;

FIG. 10 is a perspective view illustrating a label being removed for use, in accordance with the present invention;

FIG. 11 is a cross-sectional view taken generally along line 11-11 of FIG. 6, illustrating magnetic coupling of a marker and display map in accordance with the present invention;

FIG. 12 is a cross-sectional view taken generally along line 12-12 of FIG. 6, illustrating a pin label inserted into a cork board display map or the like, in accordance with the present invention;

FIG. 13 is a diagrammatic view, similar to FIG. 6, illustrating the use of peg board material, with a peg marker exploded therefrom;

FIG. 14 is a cross-sectional view taken generally along line 14-14 of FIG. 13, illustrating the peg member inserted into the peg board material, in accordance with the present invention; and

FIG. 15 is a cross-sectional view illustrating the removable connection between a display map and a marker using hook and loop material.

### DETAILED DESCRIPTION OF THE PREFERRED EMBODIMENTS

As shown in the accompanying drawings, for purposes of illustration, the present invention resides in an apparatus for labeling and identifying the location of individuals. The invention is intended to geographically mark the location of people with moveable, reusable and non-destructive markers 12 which can be customized by the user to represent specific persons. The invention is versatile, user-tailored and reusable.

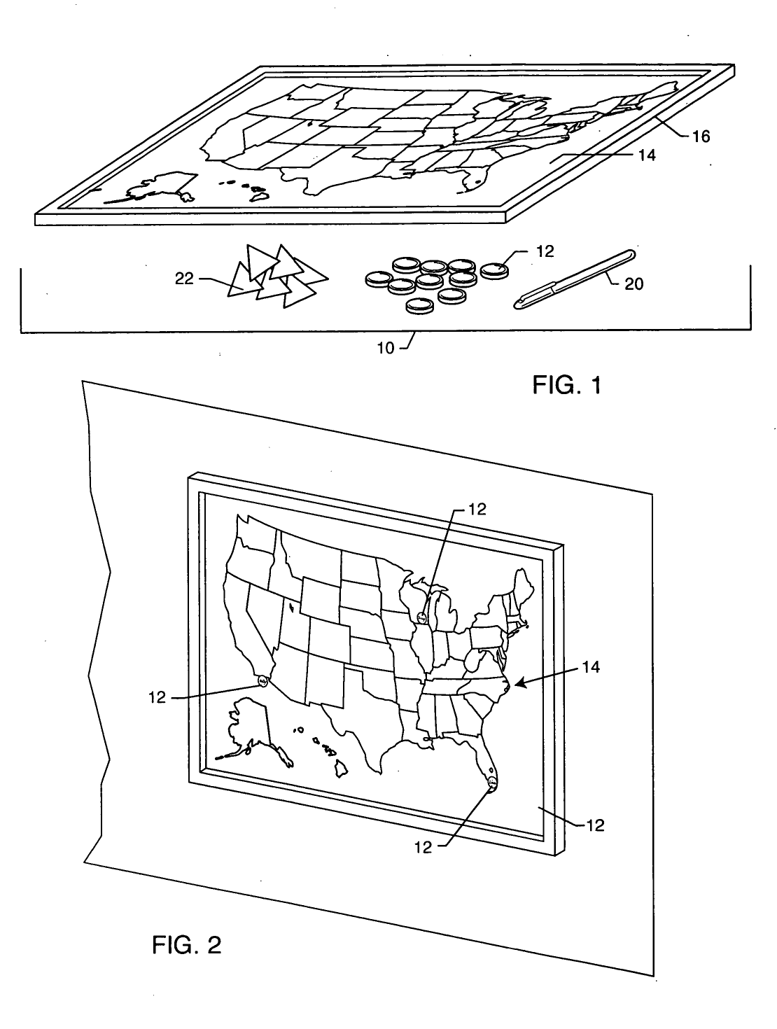

With reference now to FIGS. 1 and 2, the apparatus 10 is comprised of various components, which can be sold in the form of a kit or the like. The apparatus 10 includes a plurality of markers 12 which are adapted and configured to be removably coupled to a display surface which includes a map 14. Preferably, the display surface 14 includes an aesthetically appealing frame 16 so as to be hung on a vertical surface 18, such as a wall or a refrigerator or the like. As such, on the rear surface of the display map 14, there are positioned magnets, hooks, wire, etc., for hanging the display map apparatus 14 on a wall, or removably attaching the display surface map 14 on a refrigerator or the like so as to be easily viewed.

The kit or apparatus 10 of the present invention preferably includes a plurality of markers 12 such that the user can track the location of a plurality of individuals, such as family members or friends. The present invention is particularly adapted for use by parents or grandparents or the like for tracking their children or grandchildren. In this manner, parents or grandparents can track family members who are in college, in the military, residing in different portions of a state, country or the world, etc.

As such, each marker 12 is adapted to include indicia representing an individual. As illustrated in FIG. 1, a permanent marking pen or the like 20 may be included in the kit 10 for writing directly upon the upper surface of the marker 12. Alternatively, a plurality of labels 22 are provided in the kit 10 such that the pen 20 can be used to write on the labels 22 which can be removed from a sheet of labels, or have a backing thereof removed so as to be placed on the upper surface of the marker 12 to identify, or such that the marker 12 represents an individual. It will be readily understood that the marker 12 could represent not only an individual, but a family, such as a son or daughter who is married and has children.

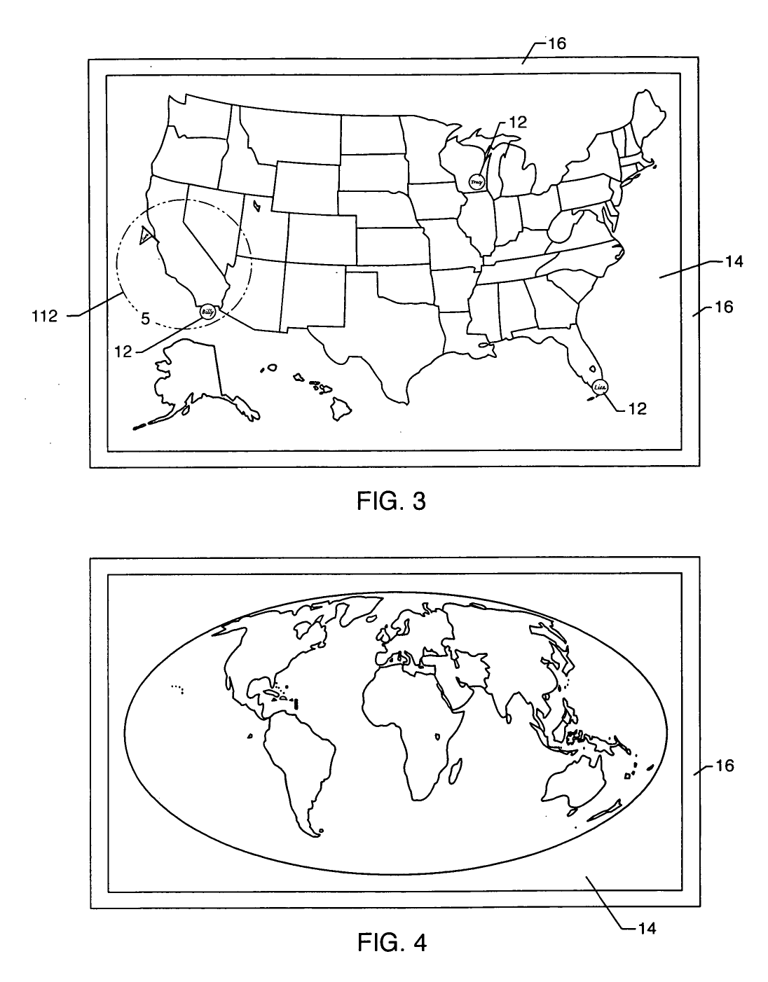

With reference now to FIGS. 2-4, once the marker 12 has been properly identified, it is placed on the display surface 14, containing a map or a representation of a geographical location such as the map of the United States, as illustrated in FIGS. 2 and 3.

With particular reference to FIG. 3, a map of the United States is shown with a plurality of markers 12 and 112 attached thereto each having indicia 24 written thereon, or on a sticker 22 adhered thereto, representing and designating a specific person. As will be more fully discussed herein, the markers 12 are removably attachable to the display surface 14 to accommodate the instance when the individual or family moves from one location to another.

It will be appreciated that the geographical map is not limited to the United States. Instead, the map may represent a single state of the United States where various family members live, and include additional indicia representing various cities 28, etc. Alternatively, as illustrated in FIG. 4, the geographical map on the display surface 14 may represent the entire world so as to track the location of the individuals throughout the entire world. Such may be helpful, for instance, when children or grandchildren or the like are attending the various universities throughout the world, are deployed in the military throughout the world, etc. Of course, other geographical maps can be used, such as North America or another continent, a province, another country, etc. As such the invention is not intended to be limited to any particular type of geographical map.

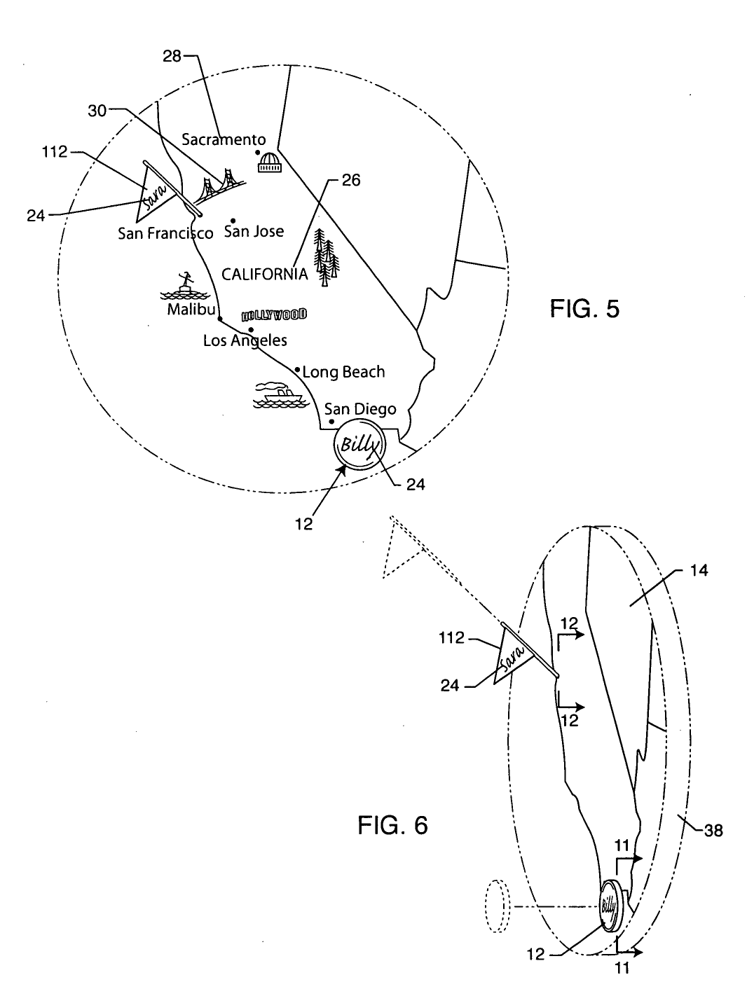

With reference now to FIG. 5, the geographical map on the display surface 14 preferably includes indicia identifying the various countries, states, provinces, etc. In the case of a map of the United States, each state would be labeled with its indicia, such as the illustrated State of California 26. In addition, a number of cities 28 are also indicated on the map. It will be appreciated by those skilled in the art that the number of cities 28 actually printed onto the display map 14 varies according to the representation of the map. For example, when a world map is illustrated, only the individual countries, and perhaps a few select cities 28, such as the Nation's capitals will be printed thereon. However, when a map of an individual country, such as the United States, is illustrated, more cities 28 can be printed thereon. It is anticipated that the map of the United States can be labeled with 30 or more of the most populated cities 28. They may include capital cities of each state. Moreover, in a particularly preferred embodiment, as illustrated in FIG. 5, the display map 14 will include landmark indicia 30 of the geographical location. For example, in FIG. 5, the State of California 26 includes various landmark indicia 30, including “Hollywood”, the Golden Gate Bridge 30, etc. Natural landmarks, such as the illustrated Redwood Forest, rivers, lakes, etc., can also be illustrated and included in the display map 14, as space permits. The landmark indicia 30 or pictures typically represent something that the city or state is proud of or something that the city or state is commonly associated with or known for.

With reference now to FIGS. 6-11, in a particularly preferred embodiment, the markers 12 and display surface 14 comprise materials such that a magnetic connection or attraction is formed therebetween. As such, the display surface 14 is typically comprised of a sheet metal or a magnetized surface 32. If sheet metal is used, anti-rust paint may be used in both the front and back of the metal. If a wood or plastic base 32 is used, a coat of magnetic or metallic paint may need to be applied thereto. Alternatively, a thin layer of magnet material is adhered or otherwise affixed onto the wood or plastic base. The geographical map 34 is affixed to the top of the magnetic surface or base 32. The map 34 can be prepared on high-quality gloss paper, glossy cardstock, or a think plastic overlay. Alternatively, the map 34 may be silk screened or otherwise printed directly onto the sheet metal or magnetized surface 32.

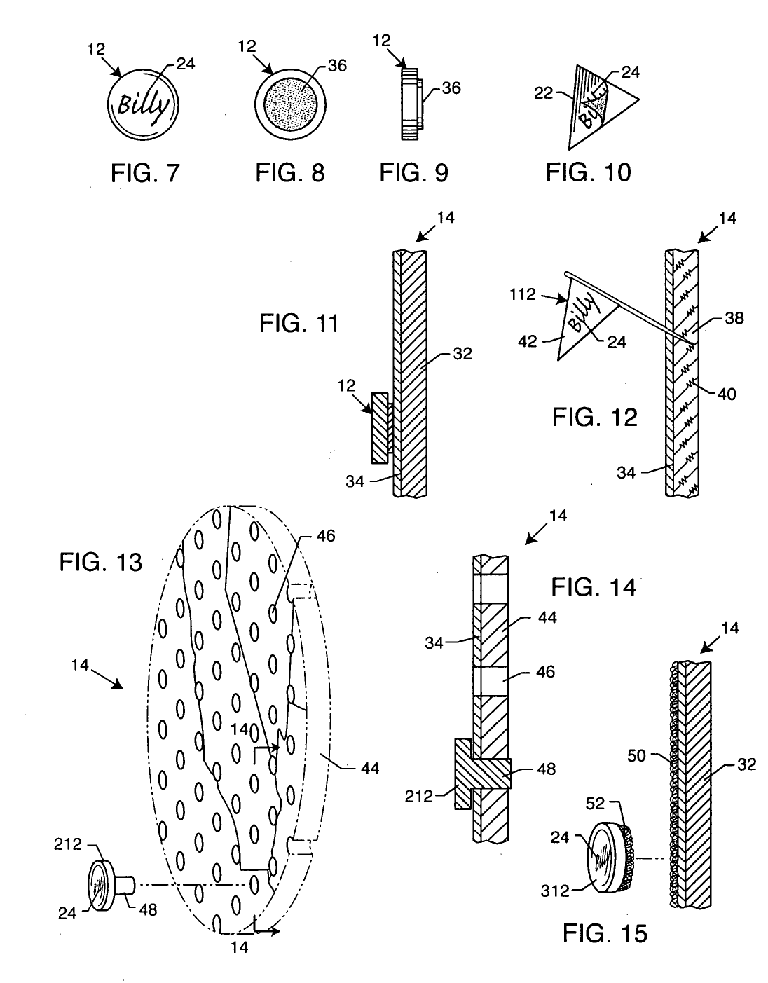

The marker 12 consists of, or includes, a magnet 36. The marker 12 can include an overlay material which permits the indicia 24 representing the individual to be printed thereon, as illustrated in FIG. 7. Alternatively, a label 22 having the indicia 24 written thereon is adhered onto an upper surface as of the magnet 36. The labels or stickers 22 can come as a sheet of labels or stickers, or be individual with a removable backing to expose an adhesive surface, as shown in FIG. 10. A benefit of the labels 22 is that if the markers 12 represent different individuals over time, an old label can be removed, or a new label 22 placed over the old label such that the marker 12 now represents a new individual. It will be appreciated that the marker 12, instead of including a magnet 36, can instead include a metal material which is attracted to a magnet if the display surface 14 consists of a magnetic sheet or other magnetic material. In any event, a removable magnetic connection, as illustrated in FIG. 11, is desired. In this manner, a marker 12 can be placed on or adjacent to a city or landmark on the geographic map display 14, as illustrated in FIG. 6. As discussed above, if that individual or family moves, the marker 12 can be positioned in the new location or residence of that individual or family.

With reference now to FIGS. 6 and 12, the present invention is not necessarily limited to a magnetic connection between the markers 12 and the display map surface 14. Instead, a marker 112 can include a projection 38 for insertion through the map 34 and into a underlying base material 40, such as cork board material or the like. As such, the marker 112 can comprise a pin or the like having indicia 24 representing or designating the specific person or family written on a labeling or flag portion 42 thereof. It will be appreciated that such flag 42 portion can be comprised of a label 22, such as that illustrated in FIG. 10, which is adhered to the projection or pin 38. A disadvantage of this particular embodiment is that over time, the map display surface 34 will have pin holes therethrough when the pin 38 is inserted into different geographic locations as the individual or family moves locations.

With reference now to FIGS. 13 and 14, the display surface board 14, can be comprised of a peg board material 44, which includes a plurality of spaced-apart apertures 46, as is well known in the art. The marker 212, having the indicia 24 representing the individual thereon, has a projection or peg 48 adapted to be inserted into an aperture or a hole 46 of the peg board material 44, or as illustrated in FIG. 14. The geographic map is either overlayed or printed upon the peg board material 44. The peg or projection 48 extends into a hole 46 of the peg board material 44 most adjacent to where the individual resides or is currently located.

With reference now to FIG. 15, in yet another embodiment, the base material 32 of the display map 14 includes a hook or loop upper surface 50. Typically, loop material 50 is affixed to the base 32 on the outer surface thereof. The display map 14 is imprinted thereon. For example, a map of the United States, as illustrated in FIG. 3, could be imprinted onto the loop material 50 on the base 32 of the display board 14. Markers 312 include a corresponding hook or loop material 52 on a bottom surface thereof so as to be removably attachable to the hook or loop outer surface 50 of the display map 14. Such hook and loop material 50 and 52 is often sold under the Velcro trade name. Once again, the marker 312 will include indicia 24 written thereon by a pen 20 or the like, or have a label associated therewith or adhered thereon, as discussed above. In this manner, the marker 312 will designate and represent a specific person or family.

From the foregoing, it will be readily understood that in use, the user writes upon the marker 12 or label 22, which is subsequently affixed to or associated with an outer surface of the marker 12, with identifying indicia 24 representing and designating a person or family. The display surface 14 including the selected map indicia is hung on a vertical surface, such as a refrigerator or a wall so as to be easily viewed. The one or more markers 12 representing individuals are then placed on the map where the individual or family is located or resides. In this manner, for example, grandparents can quickly look at a map and see the location of their children and grandchildren, for example thoughout the United States. As the families or individuals move due to employment changes, moving away to college, military deployment, etc., the grandparents can remove the markers 12 from their original location and place them in the new location on the map.

The display surface 14 of the present invention can be labeled according to the end user and the geographic map. For example, a legend or title can be imprinted thereon, such as “Where in the United States are my children and grandchildren?” Alternatively, “Where in the world are my children and grandchildren?” Special editions of the invention could include a military oriented map, wherein the map would include U.S. military bases around the world, and include corresponding pictures. A theme of red, white and blue and/or camouflage could be used. Details of each base could be included (i.e., largest U.S. military base, flight school, etc.) Alternatively, for example, the invention could be directed to children and grandchildren in college, and the map could include the largest U.S. colleges, and corresponding pictures of campus landmarks, sports teams, etc. The present invention also contemplates a built-in system of keeping and updating addresses of the various individuals who are tracked, as well as a birthday-labeling system.

Although several embodiments have been described in detail for purposes of illustration, various modifications may be made to each without departing from the scope and spirit of the invention. Accordingly, the invention is not to be limited, except as by the appended claims.

1. An apparatus for labeling and identifying the location of individuals, comprising:
a display surface including a map;
a plurality of markers releasably attachable to the display surface, wherein each marker is adapted to include indicia representing an individual;
whereby the location of an individual is identified and labeled by placing the marker representing that individual on the map of the display surface where that individual is located.

2. The apparatus of claim 1, wherein the display surface map comprises a map of the world, a continent, a country, or a state or province of a country.

3. The apparatus of claim 2, wherein the map includes indicia identifying the one or more countries or one or more states or provinces.

4. The apparatus of claim 3, wherein the map further includes landmark indicia of the one or more countries or one or more states or provinces.

5. The apparatus of claim 1, wherein the markers each include an upper surface adapted to be written upon with identifying indicia of an individual or receive a label that is written upon with identifying indicia of an individual.

6. The apparatus of claim 5, wherein the display surface is comprised of a magnetically attractable metal or magnetic material.

7. The apparatus of claim 6, wherein the markers are comprised of magnetically attractable metal or magnetic material so as to be magnetically attached to the display surface.

8. The apparatus of claim 2, wherein the markers each include a projection for insertion into the display surface map.

9. The apparatus of claim 8, wherein the display surface map comprises pegboard material, and the marker projections comprise pegs.

10. The apparatus of claim 2, wherein the display surface map comprises hook or loop material, and the markers include corresponding hook or loop material for removable attachment to the display surface map.

11. The apparatus of claim 2, including means for supporting the display surface map on a vertical surface.

12. The apparatus of claim 11, including a frame surrounding the display surface map.

13. An apparatus for labeling and identifying the location of individuals, comprising:
a display surface including a map of the world, a continent, a country, or a state or province of a country;
a plurality of markers releasably attachable to the display surface, wherein each marker includes an upper surface adapted to be written upon with identifying indicia of an individual or receive a label that is written upon with identifying indicia of an individual so as to represent that individual;
wherein the display surface is comprised of a magnetically attractable metal or magnetic material; and
wherein the markers are comprised of magnetically attractable metal or magnetic material so as to be magnetically attached to the display surface;
whereby the location of an individual is identified and labeled by placing the marker representing that individual on the map of the display surface where that individual is located.

14. The apparatus of claim 13, wherein the map includes indicia identifying the one or more countries or one or more states or provinces.

15. The apparatus of claim 14, wherein the map further includes landmark indicia of the one or more countries or one or more states or provinces.

16. The apparatus of claim 13, including means for supporting the display surface map on a vertical surface.

17. The apparatus of claim 13, including a frame surrounding the display surface map.

18. A method of labeling and identifying the location of individuals on a map, comprising the steps of:
providing a display surface having a map;
providing a plurality of markers adapted to be releasably attached to the display surface;
writing upon an upper surface of the marker identifying indicia representing an individual or attaching a label to the marker having identifying indicia representing an individual; and
placing the marker on the map where the individual resides.

19. The method of claim 18, including the step of supporting the display surface map on a vertical surface.

20. The method of claim 18, wherein the display surface map comprises a map of the world, a continent, a country, or a state or province of a country.
